(19) United States
(12) Patent Application Publication
(10) Pub. No.: US 2005/0128735 A1
(43) Pub. Date: Jun. 16, 2005

(54) Head-mounted instruments

(76) Inventors: Neil Anthony Atkins, Windsor (GB); Mark Lavelle, Kineton Road Southam (GB)

Correspondence Address: BARNES & THORNBURG, P.O. BOX 2786, CHICAGO, IL, 60690-2786, US

(21) Appl. No.: 10/948,890

(22) Filed: Sep. 23, 2004

(30) Foreign Application Priority Data
Sep. 26, 2003 (GB) 0322551.3

(51) Int. Cl. F21V 21/084

(52) U.S. Cl. 362/105

(57) ABSTRACT

A head mounted instrument, such as an indirect ophthalmoscope, has an electrically powered instrument unit and a headband for carrying the instrument unit at or adjacent the front of the wearer's head. A manually adjustable member on the headband enables the effective size of the latter to be adjusted to suit the size of the wearer's head, and is located at the rear of the user's head when the headband is worn. Power for the instrument is provided by one or more electric batteries located or locatable on the headband such that the weight of the battery/batteries is centred substantially at the rear of the user's head when the headband is worn, the battery/batteries being supported or supportable on the headband through mounting formations so that the battery/batteries are supported or supportable on the headband other than through the intermediary of the adjustment member.

### FIELD OF THE INVENTION

This invention relates to head-mounted instruments and particularly, but not exclusively, to head-mounted indirect ophthalmoscopes.

### BACKGROUND TO THE INVENTION

A conventional head-mounted indirect ophthalmoscope comprises a headband a front region of which carries an ophthalmoscope unit and the rear of which has an adjustment knob for adjusting the effective size of the headband (e.g. by altering the tension in the headband) to suit the size of the wearer's head. The ophthalmoscope unit has a light source powered by a separate battery pack which can be mounted on the user's belt or a wall, or is alternatively powered by a wall-mounted mains electricity power supply. The ophthalmoscope unit also has image-receiving optics by which the user (e.g. doctor or optician) of the ophthalmoscope views a stereoscopic image of a patient's retina illuminated by the light from the light source.

In one known head-mounted indirect ophthalmoscope, the adjustment knob for adjusting the tension applied to the headband also serves to accommodate a battery pack, an arrangement which is cumbersome particularly since an electrical wire extends between the battery pack and the light source and this wire becomes twisted as the knob is rotated and can be placed under tension at the extremes of rotary movement of the knob. The invention was devised to provide a head-mounted indirect ophthalmoscope with an improved arrangement of electrical power supply to the light source of the ophthalmoscope unit.

### SUMMARY OF THE INVENTION

According to the invention a head-mounted instrument comprises an electrically powered instrument unit, a headband for carrying the instrument unit at or adjacent the front of the wearer's head, the headband carrying adjustment means having a manually adjustable member for manually adjusting the effective size of the headband to suit the size of the wearer's head, the adjustment member being located at the rear of the user's head when the headband is worn, electric battery means for powering the instrument unit, the battery means being located or locatable on the headband such that the weight of the battery means is centred substantially at the centre of the rear of the user's head when the headband is worn, the battery means being supported or supportable on the headband other than through the intermediary of the adjustment member.

Supporting the battery means on the headband independently of the adjustment member has the advantage over the known instrument that the adjustment member is not encumbered by the battery means so movement of the adjustment member is not impeded by the weight or inertia of the battery means or by the need to maintain an electrical connection between the adjustment member and the instrument unit throughout the range of movement of the adjustment member. Moreover, where the battery means is detachable (or includes a detachable battery pack) for recharging, the separate functionality of the battery means and the adjustment member simplifies the detachable mounting of the battery means on the headband.

The adjustment member may be in the form of a manually rotatable knob projecting centrally from the rear of the headband, rotation of the knob altering the effective size of the headband, e.g. by altering the tension in the headband. The central positioning of the adjustment member enables the instrument to be used by a right or left-handed person.

A front surface of the battery means may be concave, to fit snugly against the back of a wearer's head.

The battery means may comprise a battery pack which is removable from the headband for recharging of the battery pack, and the battery pack may have two cell compartments disposed on respective sides of a central slot which accommodates the adjustment means. Instead of a single battery pack with a central slot, there may be two battery packs located or locatable on the headband on either side of the adjustment means, providing a symmetrical arrangement.

The battery means may further comprise a base unit onto which the battery pack can be removably fitted and which is permanently or semi-permanently attached to the headband, the base unit being electrically wired to the instrument unit. The base unit may have electrical contacts co-operating with contacts on the battery pack.

The battery pack is preferably chargeable either when mounted on the headband or when removed from the headband.

In order to charge the battery pack, the instrument may be complemented by an electrical charger capable of charging the battery pack when mounted on the headband as well as a spare battery pack, and the charger is preferably capable of undertaking these two charging functions simultaneously.

In the preferred embodiment the instrument unit is an ophthalmoscope unit and the instrument is an indirect ophthalmoscope.

### BRIEF DESCRIPTION OF THE DRAWINGS

A head-mounted indirect ophthalmoscope according to the invention will now be described, by way of example, with reference to the accompanying drawings, in which:

FIG. 1 is a perspective view of the ophthalmoscope;

FIG. 2 is a perspective view of the ophthalmoscope of FIG. 1 with a battery pack removed;

FIG. 3 is a perspective view of the separated battery pack;

FIG. 4 is a perspective view of a charger for the ophthalmoscope; and

FIG. 5 is a perspective view of the ophthalmoscope of FIG. 1 mounted in the charger of FIG. 4, without a spare battery pack.

### DETAILED DESCRIPTION OF THE PREFERRED EMBODIMENT

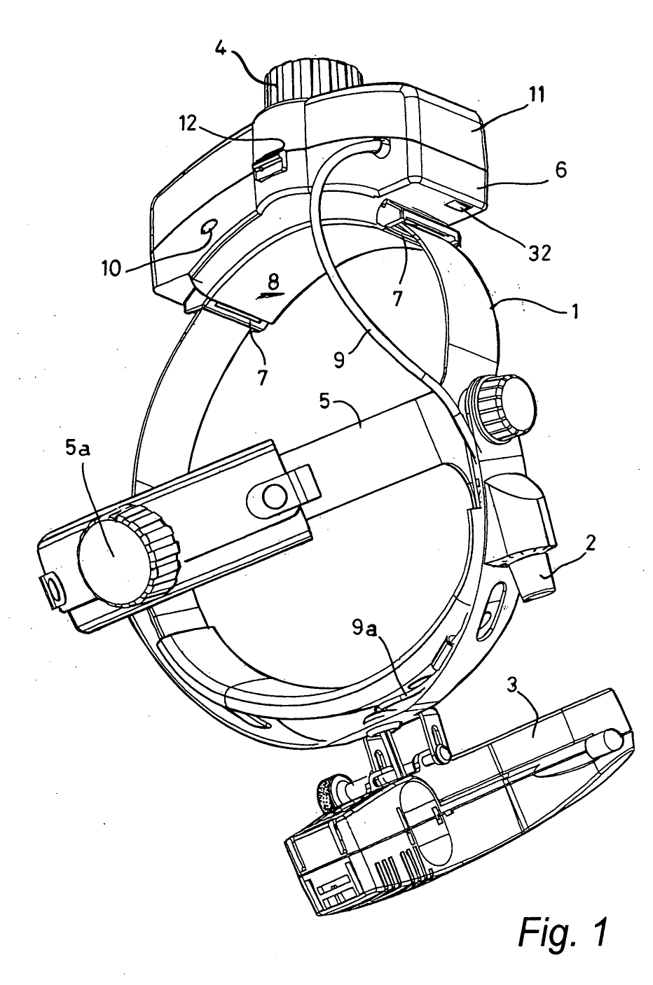

Referring to FIG. 1, the ophthalmoscope has a headband 1 the front region of which carries an ophthalmoscope unit 3 having a light source and optics for viewing an image of a patient's retina illuminated by the light source, the intensity of which is controllable by a control 2. The tension in the headband 1 is adjusted by adjustment means including a rotatably adjustable knob 4 which projects centrally from the ophthalmoscope at the rear thereof. An upper loop 5 extends from one side of the headband to the other and, in use, extends over the top of the wearer's head. An adjusting knob 5a controls the effective length of the loop 5.

To the rear of the headband is permanently attached a battery base unit 6 having slots 7 through which lengths of the headband 1 extend. Between the slots 7 the front surface 8 of the base unit 6 is concave, to fit snugly against the back of the wearer's head. An electrical wire 9 passes from the base unit 6 to the light control 2 and a line 9a continues to the ophthalmoscope unit 3. The base unit 6 has an indicator light 10 displaying the extent of battery charge. A battery pack 11 is detachably fitted to the base unit 6.

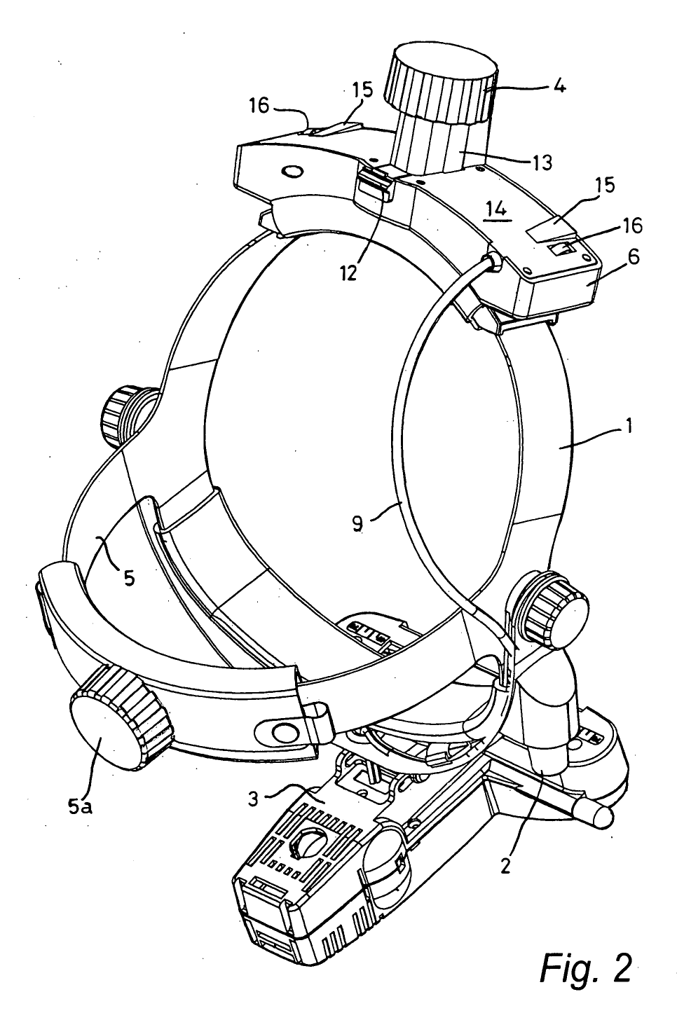

As best seen in FIG. 2, a central region of the base unit 6 has a battery pack release clip 12 adjacent a rearwardly projecting wall 13 which surrounds a drive shaft (not shown) for the adjustment knob 4. The rear convex surface 14 of the base unit 6 has two spaced locating ramps 15 positioned just inwardly of two electrical contacts 16.

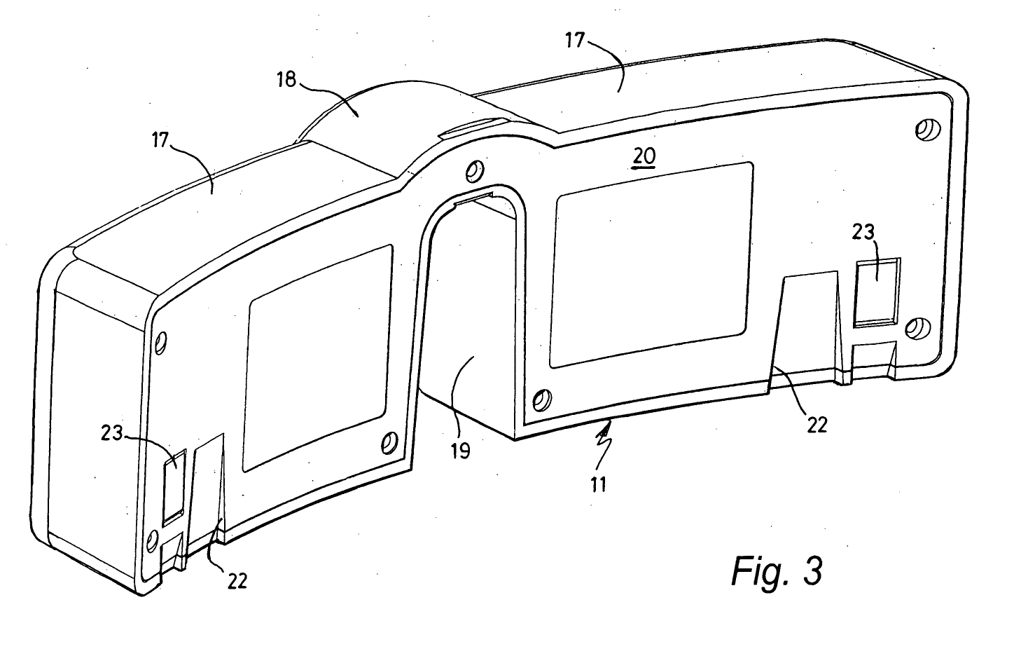

It can be seen from FIG. 3 that the battery pack 11 has two cell compartments 17 interconnected by a saddle 18 beneath which is a slot 19. The front surface 20 of the battery pack 11 is concave and complements the convex rear surface 14 of the base unit 6, and this concave surface 20 has two tapering recesses 22 adjacent two electrical contacts 23. When the battery pack 11 is fitted to the base unit 6 the tapering ramps 15 slide into the tapering recesses 22 and the slot 19 accommodates the wall 13. In its fitted position, the two contacts 16 respectively engage the two contacts 23 and the clip 12 engages a formation on the battery pack 11. The symmetrical shape of the battery pack 11 ensures that its centre of gravity is disposed centrally at the rear of the wearer's head. The battery pack 11 can be removed from the base unit 6 by releasing the clip 12 and sliding the battery pack 11 away from the base unit, the centre of gravity of which is also disposed centrally at the rear of the wearer's head.

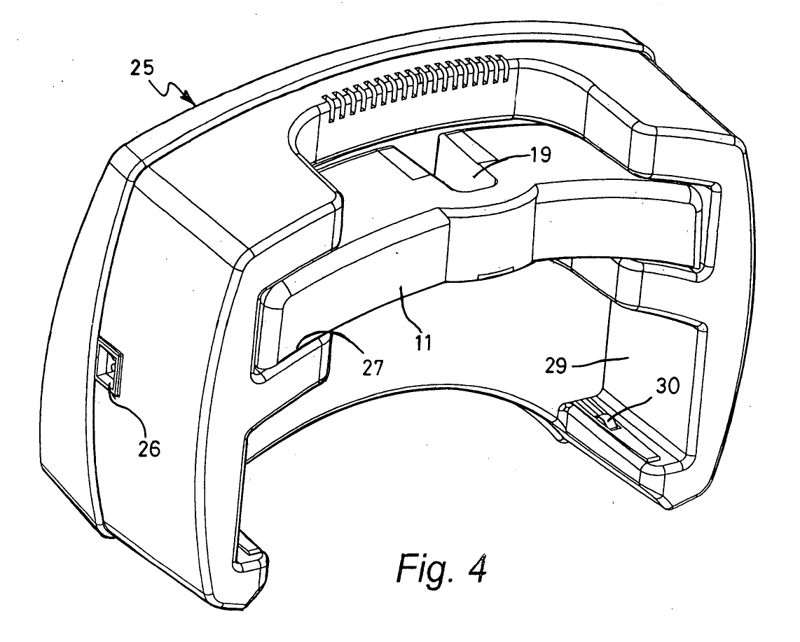

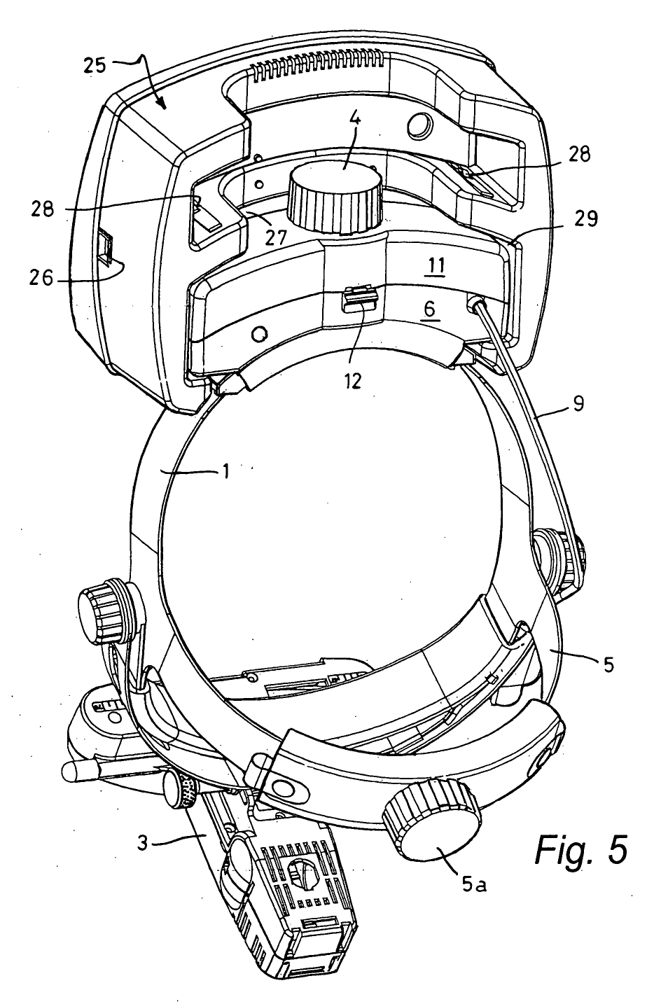

FIG. 4 shows a charger 25 for charging the battery pack 11. The charger has an outer casing one side of which has a socket 26 to receive power at 12 volts a power supply unit. An upper part of the charger 25 has a slot 27 shaped to receive the battery pack 11 which is shown in position in the slot 27 in FIG. 4. It will be appreciated that the battery pack 11 illustrated in FIG. 4 may be a spare battery pack, allowing one pack to be charged whilst another is in use on the ophthalmoscope. At the sides of the upper slot 27 the charger 25 has electrical contacts 28 (FIG. 5) which engage the contacts 23 on the battery pack 11 when the latter is inserted in the slot 27.

The lower portion of the charger 25 has a larger slot 29 with two ledges each provided with an electrical contact 30 (FIG. 4). This larger slot 29 accommodates a base unit 6 with a battery pack 11 attached, enabling a battery pack 11 to be charged whilst still attached to the base unit (FIG. 5). To achieve this the base unit 6 has two forwardly facing electrical contacts 32 one of which is visible in FIG. 1. These contacts 32 engage the pair of contacts 30 in the charger 25 when the charger is charging the battery pack 11 mounted in the ophthalmoscope. The charger 25 can simultaneously charge a spare battery pack 11 (FIG. 4) and a battery pack 11 mounted in the ophthalmoscope, as shown in FIG. 5.

It will be appreciated that many variations may be made to the features of the described instrument without departing from the scope of the invention as defined in the claims. Furthermore, the battery means of claim 1 can be any arrangement of at least one battery supportable on the headband in the way required by claim 1 and able to power the instrument. Thus, for example, the battery means may comprise a single battery or a plurality of batteries. If the battery means comprises a plurality of batteries these may be contained in, or held together to form, one or more battery packs or may be directly attachable to the headband individually.

1. A head-mounted instrument comprising an electrically powered instrument unit, a headband for carrying the instrument unit at or adjacent the front of the wearer's head, the headband carrying a manually adjustable member for manually adjusting the effective size of the headband to suit the size of the wearer's head, the adjustment member being located at the rear of the user's head when the headband is worn, electric battery means for powering the instrument unit, the battery means being located or locatable on the headband such that the weight of the battery means is centred substantially at the centre of the rear of the user's head when the headband is worn, the battery means being supported or supportable on the headband other than through the intermediary of the adjustment member.

2. An instrument according to claim 1, in which the adjustment member is in the form of a manually rotatable knob projecting centrally from the rear of the headband.

3. An instrument according to claim 1, in which a front surface of the battery means is concave, to fit snugly against the back of a wearer's head.

4. An instrument according to claim 1, in which the battery means comprises a battery pack which is removable from the headband for recharging of the battery pack.

5. An instrument according to claim 4, in which the battery pack has two cell compartments disposed on respective sides of a central slot which accommodates the adjustment means.

6. An instrument according to claim 4, in which the battery means comprises two battery packs located or locatable On the headband on either side of the adjustment member providing a symmetrical arrangement.

7. An instrument according to claim 4, in which the battery means further comprises a base unit onto which the battery pack can he removably fitted and which is permanently or semi-permanently attached to the headband, the base unit being electrically wired to the instrument unit.

8. An instrument according to claim 7, in which the base unit has electrical contacts co-operating with contacts on the battery pack.

9. An instrument according to claim 4, in which the battery pack is chargeable either when mounted on the headband or when removed from the headband.

10. An instrument according to claim 4, further comprising an electrical charger capable of charging the battery pack when mounted on the headband as well as a spare battery pack.

11. An instrument according to claim 10, in which the charger is capable of undertaking these two charging functions simultaneously.

12. An instrument according to claim 1, in which the instrument unit is an ophthalmoscope unit and the instrument is an indirect ophthalmoscope.
